(19) United States
(12) Patent Application Publication
(10) Pub. No.: US 2025/0284875 A1
(43) Pub. Date: Sep. 11, 2025

(54) METHOD AND APPARATUS FOR PROVIDING A PROMPT TO A LARGE LANGUAGE MODEL ENGINE

(71) Applicant: Emtelligent Software Ltd., Vancouver (CA)

(72) Inventors: Timothy William O'CONNELL, Vancouver (CA); Anoop Dipesh SARKAR, Vancouver (CA)

(21) Appl. No.: 19/065,900

(22) Filed: Feb. 27, 2025

Related U.S. Application Data
(60) Provisional application No. 63/562,858, filed on Mar. 8, 2024.

(51) Int. Cl. G06F 40/103; G06F 16/242; G06F 16/36

(52) U.S. Cl. CPC G06F 40/103; G06F 16/243; G06F 16/367

(57) ABSTRACT

A method and apparatus is provided for providing prompt input to a large language model (LLM) engine that includes receiving one or more input documents containing unstructured text data, receiving a prompt that references the one or more input documents and is associated with a task for the LLM engine to perform utilizing the one or more input documents, generating, utilizing a fine-tuned language model engine specific to the context structured data based on at least one of the one or more input documents, and transmitting, to the LLM engine, the one or more input documents, the prompt, and the structured data together with instructions to cause the LLM engine to perform the task based on the one or more input documents and the structured data.

### FIELD

The present disclosure relates generally to providing a prompt to a large language model engine.

### BACKGROUND

Electronic record keeping generally includes databases of documents, which often include unstructured text data, or free-text. One such example is medical record systems in which the type of documentation include in medical record documents typically includes unstructured data in the form of free-text notes, such as in a “clinic visit note” often recorded after a family doctor visit, for example. In addition, numerous diagnostic tests and procedures in medicine are similarly documented in free-text form, such as in radiology, pathology, and operative notes.

It is often desirable to be able to extract helpful information from the documents in an electronic record keeping system. However, the unstructured data that is included in, for example, free-text notes in medical documents, often means that review of these notes is conducted manually. For example, review of documents in a medical record system may require highly trained doctors or nurses to manually review these documents for whatever the various use cases are. The cost and time involved in having highly-skilled, high-cost medical professionals perform document reviews, and correspondingly, can result in such manual document review being prohibitive.

Recent technological developments in artificial intelligence have seen the emergence of large language models (LLMs) has been proposed as a possible tool to assist in reviewing and analyzing electronic documents stored in an electronic record system. However, one issue with using LLMs is that these models can make up, or “hallucinate”, factually incorrect information to support the generated output. In cases in which the results of the LLM will be relied on with serious implications, such as in medical, legal, and financial contexts, hallucinations by an LLM create serious reliance issues that are a significant barrier to adoption of LLMs for these document review and analysis tasks.

Improvements in performing document analysis and review using LLMs are desired.

### SUMMARY

According to one aspect of an embodiment, the present disclosure provides a method for providing prompt input to a large language model (LLM) engine that includes receiving one or more input documents containing unstructured text data, receiving a prompt that references the one or more input documents and is associated with a task for the LLM engine to perform utilizing the one or more input documents, generating, utilizing a fine-tuned language model engine, structured data based on at least one of the one or more input documents, and transmitting, to the LLM engine, the one or more input documents, the prompt, and the structured data together with instructions to cause the LLM engine to perform the task based on the one or more input documents and the structured data.

In an example, generating the structured data includes identifying, in the one or more input documents, a span of text, and identifying a concept that is associated with text included in the identified span of text, wherein the structured data includes the identified concept and an identification of the identified span of text associated with the identified concept.

In an example, identifying a concept associated with the text in the identified span of text comprises performing disambiguation of an ambiguous term included in the span of text.

In an example, identifying the concept that is associated with text included in the identified span of text comprises identifying two or more concepts associated with the text included in the span of text and a relationship between the two or more concepts.

In an example, the one or more input documents are associated with a context, and the fine-tuned language model engine is specific to the context.

In an example, the context is medicine, and the one or more input documents are patient medical documents.

In an example, the fine-tuned language model engine specific to the context is trained using medical ontologies and human labelled medical data.

In an example, the medical ontologies include SNOMED-CT.

In an example, the method further includes receiving from the LLM engine an output resulting from performing the task based on the one or more input documents and the structured data.

In an example, the method further includes transmitting the output to a remote device, or displaying the output on a display.

According to a further aspect of an embodiment, the present disclosure provides an apparatus for providing prompt input to a large language model (LLM) engine that includes at least one processor, and at least one memory stored instructions wherein the instructions, when executed by the at least one processor, cause the processor to receive one or more input documents containing unstructured text data, receive a prompt that references the one or more input documents and is associated with a task for the LLM engine to perform utilizing the one or more input documents, generate structured data based on at least one of the one or more input documents, and transmit, to the LLM engine, the one or more input documents, the prompt, and the structured data together with instructions to cause the LLM engine to perform the task based on the one or more input documents and the structured data.

In an example, the instructions, when executed by the at least one processor, cause the processor to generate the structured data comprises instructions that, when executed by the at least one processor, cause the processor to identify, in the one or more input documents, a span of text, identify a concept that is associated with text included in the identified span of text, wherein the structured data includes the identified concept and an identification of the identified span of text associated with the identified concept.

In an example, the instructions, when executed by the at least one processor, cause the processor to identify a concept associated with the text in the identified span of text comprises instructions that, when executed by the at least one processor, cause the processor to perform disambiguation of an ambiguous term included in the span of text.

In an example, the instructions, when executed by the at least one processor, cause the processor to identify the concept that is associated with text included in the identified span of text comprises instructions that, when executed by the at least one processor, cause the processor to identify two or more concepts associated with the text included in the span of text and a relationship between the two or more concepts.

In an example, the one or more input documents are associated with a context, and the structured data is generated by a fine-tuned language model engine that is specific to the context.

In an example, the context is medicine, and the one or more input documents are patient medical documents.

In an example, the fine-tuned language model engine specific to the context is trained using medical ontologies and human labelled medical data.

In an example, the medical ontologies include SNOMED-CT.

In an example, the instructions, when executed by the at least one processor, further cause the processor to receive from the LLM engine an output resulting from performing the task based on the one or more input documents and the structured data.

In an example, the instructions, when executed by the at least one processor, further cause the processor to transmit the output to a remote device, or display the output on a display.

According to a further aspect of an embodiment, the present disclosure provides a computer readable medium having stored thereon computer-readable instructions that, when executed by at least one processor, cause the processor to receive one or more input documents containing unstructured text data, receive a prompt that references the one or more input documents and is associated with a task for the LLM engine to perform utilizing the one or more input documents, generate structured data based on at least one of the one or more input documents, and transmit, to the LLM engine, the one or more input documents, the prompt, and the structured data together with instructions to cause the LLM engine to perform the task based on the one or more input documents and the structured data.

In an example, the instructions, when executed by the at least one processor, cause the processor to generate the structured data comprises instructions that, when executed by the at least one processor, cause the processor to identify, in the one or more input documents, a span of text, identify a concept that is associated with text included in the identified span of text, wherein the structured data includes the identified concept and an identification of the identified span of text associated with the identified concept.

In an example, the instructions, when executed by the at least one processor, cause the processor to identify a concept associated with the text in the identified span of text comprises instructions that, when executed by the at least one processor, cause the processor to perform disambiguation of an ambiguous term included in the span of text.

In an example, the instructions, when executed by the at least one processor, cause the processor to identify the concept that is associated with text included in the identified span of text comprises instructions that, when executed by the at least one processor, cause the processor to identify two or more concepts associated with the text included in the span of text and a relationship between the two or more concepts.

In an example, the one or more input documents are associated with a context, and the structured data is generated by a fine-tuned language model engine that is specific to the context.

In an example, the context is medicine, and the one or more input documents are patient medical documents.

In an example, the fine-tuned language model engine specific to the context is trained using medical ontologies and human labelled medical data.

In an example, the medical ontologies include SNOMED-CT.

In an example, the instructions, when executed by the at least one processor, further cause the processor to receive from the LLM engine an output resulting from performing the task based on the one or more input documents and the structured data.

In an example, the instructions, when executed by the at least one processor, further cause the processor to transmit the output to a remote device, or display the output on a display.

The term “non-transitory,” as used herein, is a limitation of the medium itself (i.e., tangible, not a signal) as opposed to a limitation on data storage persistency (e.g., RAM vs. ROM).

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic diagram showing a system in accordance with an aspect of an embodiment.

FIG. 2 is a flowchart showing a method in accordance with an example embodiment.

FIG. 3 is a schematic diagram showing components of one or more of the example embodiments.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

Generally, the present disclosure provides a method and apparatus for providing a prompt to a large language model (LLM) engine that is configured to perform a task associated the prompt utilizing one or more input documents. In the present disclosure, a fine-tuned language model generates structured data based on the one or more input documents, then transmits the structured data, the prompt, the one or more input documents, and instructions for the LLM to perform the task using the structured data in addition to the one or more input documents.

The conventional approach for utilizing an LLM engine for document review and/or analysis in a particular context, such as medical, legal, and financial contexts, primarily involves creating the LLM engine. In addition to standard training the LLM engine for generic generative purposes, creating the LLM engine may optionally include training the LLM engine specifically for the context for which it is intended to be used by. For example, a LLM engine may be trained specifically for use in a medical context utilizing medical documents or utilizing medical question-answer sets or other tasks to configure the LLM engine to specifically answer medical questions and/or perform tasks specific to the medical context.

Although the present disclosure describes example embodiments in terms of the medical context, this is for illustrative purposes only and it is understood that the same concepts described herein can be applied to any other context including, for example legal, accounting, financial, business, and so forth. In general, the embodiments of the present disclosure may be useful in cases in which it is desired for the LMM engine to be more aligned to a specific context, particularly when the specific context has it's own idiosyncratic language or terminology. In some examples, the context may have one or more specialized ontologies associated with it that represent the knowledge in that context and that can be utilized, in accordance with the embodiments of the present disclosure, to align the output of the LLM engine in accordance with the concepts in those ontologies.

In the conventional approach, the LLM engine is provided with one or more input documents, such as, for example, medical documents, and a prompt that is associated with a task to be performed by the LLM engine utilizing one or more documents. The prompt may include input text from a user such as, for example, “summarize the patient's medical history based on the attached documents”, which is associated with the task of having the LLM engine analyze the documents and generate utilizing the documents a summary of the patient's medical history based on the contents of the documents. Alternatively, or additionally, the prompt may be a template prompt such as, for example, one of a plurality of template prompts that is selected by a user that are associated with a pre-defined task.

Tasks that may be performed by an LLM engine in response to a prompt in the medical context may include, for example, reading a list of insurance approval criteria for a drug or procedure and determining, based on the patient's medical document(s), if the patient meets the criteria to receive the drug or have the procedure performed. Other use cases may include preparing letters and patient summaries, and identifying patients for clinical trials by assessing if they meet inclusion/exclusion criteria for the trial.

As noted previously, an issue with LLM engines is that these LLM engines may “hallucinate” by making up factually-incorrect information to support the generated output. In contexts in which the factual correctness of the generated output is crucial, such hallucinations are a serious problem. For example, in a medical context, an LLM making up information that that a patient is eligible for a drug or procedure when they are not actually eligible may result in harm to a patient harm, or inadvertent insurance fraud. The lack of confidence in the generated output of LLM engines due to the potential for hallucinations has resulted in LLM engines not being widely adopted for in certain contexts including, for example, medical, legal, and financial contexts.

One approach that attempts to reduce or eliminate hallucinations in the output of LLM engines is referred to as retrieval augmented generation (RAG). A RAG approach attempts to limit hallucinations by using a language model to retrieve, based on the prompt that is received, passages of verifiable information from a collection of documents or a knowledge base of facts that are assumed to contain trusted information. The portions of those documents or knowledge base are retrieved using the language model by matching the content in those documents or knowledge base to the received prompt. The language model used might be fine-tuned to the particular context of the source documents or the knowledge base. The portions from the documents and knowledge base that are retrieved by the language model sent to the LLM engine with the original prompt such that the LLM performs the task associated with the prompt utilizing the retrieved portions of the documents and knowledge base. Because the prompt is provided with portions of presumable trusted information from the source documents, hallucinations may be reduced by having the LLM engine generate its output based on those portions.

RAG approaches were designed based on the limitations of earlier LLM engines which had limited input capabilities, sometimes referred to as “input context” (not to be confused with “context” used herein to identify a particular field or industry), often limited to 4K or 8K tokens. RAG approaches, in which the LLM engine is forced to generate an answer based on the portions of the source documents that are provided to it, are better suited for LLM engines with such limited number of tokens.

By contrast to RAG approaches, embodiments of the present disclosure provides entire sets of input documents to the LLM engine, together with structured data that provides the LLM engine with information related to entity linking to ontologies and disambiguation, which are better suited than RAG approaches to take advantage of the expanded input context of modern LLM engines, which can be 32K tokens and even ranging up to 10M tokens.

RAG approaches have been shown to be useful for fact-based summaries or information retrieval types of tasks performed by LLM engines, but may be less effective in reducing hallucinations in open-ended reasoning tasks such as, for example, temporal inference, which are highly relevant for LLM engine tasks in certain contexts including, for example, medical contexts. This is because RAG approaches have typically been shown to be better suited to tasks where snippets of information are included in the output of the LLM engine, such as summarization and question answering tasks. For example, in a medical context, a RAG approach might be helpful in performing the task of producing a timeline of all procedures that a patient has undergone based on the patient's clinical notes. However, RAG approaches have been shown to have limited to no effect in improving LLM output for reasoning tasks that involve more than merely reproducing portions of the input documents to generate the LLM engine output.

Embodiments of the present disclosure, by providing both the entire input documents, as well as structured data that is generated by a fine-tuned language model, may increase the ability of the LLM engine to perform both summarization and question answering tasks, as well as reasoning tasks that require more than reproducing portions of the input documents.

As discussed previously, the approached set forth in the present disclosure uses fine-tuned language models to generate structured data that is associated with unstructured text data in the one or more input documents associated with a prompt for an LLM engine. The structured data may identify concepts that are associated with spans of text that are present in the one or more input documents, may disambiguate ambiguous terms in the one or more input documents, may identify multiple concepts that are included in the one or more input documents and identify a relationship between the concepts. The structured data, as well as all of the content of the input documents is provided to the LLM engine together with the prompt such that the LLM engine can utilize the structured data when performing the task to, for example, disambiguate concepts associated with text in the input documents. In this way, the structured data is a reference that the LLM engine may utilize, similar to, for example, a legend or a key, when performing the task based on the one or more input documents.

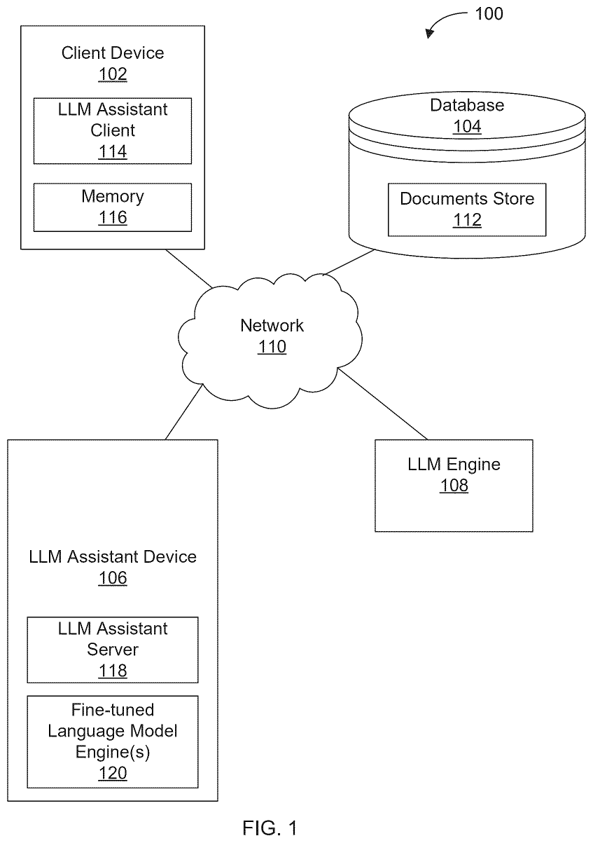

Referring now to FIG. 1, schematic representation of an example system 100 for providing a prompt to a LLM engine is shown. The system 100 includes a client device 102, a database 104, a LLM assistant device 106, and a LLM engine 108 that communicate with each other via a network 110. The network 110 may be any suitable wired or wireless network, or combination of wired and wireless networks including, for example, a local area network (LAN), or a wide area network (WAN), or a combination thereof.

The database 104 may include a document store 112 that stores electronic documents. The document store 112 may be, for example, part of an electronic record keeping system, or any other suitable document management system, that stores records for a particular context such as, for example, medical context, legal context, financial context, business context, and the like.

The client device 102 may include an LLM assistant client 114 that may be utilized to generate prompts associated with tasks to be performed on by the LLM engine 108. The LLM assistant client 114 may include a graphical user interface that is displayed on a display (not shown) of the client device 102 to enable the user of the client device to input text to be included in the prompt, or to select a template prompt associated with a predefined task. In some embodiments, text input by a user is utilized to determine one or more suggested template prompts that match the text input by the user. In some examples, the determination of the one or more template prompts based on the input text may be performed by the LLM assistant client.

The LLM assistant client 114 also enables one or more input documents to be included with the prompt. The input documents may be stored in a memory 116 of the client device, in one or more remote databases, such as the document store 112 of the database 104. The LLM assistant client 114 may retrieve copies of the input documents from the memory 116 or the database 104 and include the copies of the input documents with the prompt. Alternatively, the LLM assistant client 114 may include with the prompt references or pointers to where the documents are stored.

The LLM assistant client 114 may be, for example, an application that is stored and executed at the client device 102, or may be a web-based application hosted on a server that is accessed through a web-browser executed at the client device 102.

The LLM assistant device 106 includes a LLM assistant server 118 that is configured to interface with the LLM assistant client 114 at the client device 102. The LLM assistant server 118 may provide the graphical user interface that may be displayed at the client device 102 in some embodiments. The LLM assistant server 118 may host the web-based application that is accessed when the LLM assistant client 114 is implemented as a web-based application, as previously described.

The LLM assistant server 118 may receive a prompt from the LLM assistant client 114. The prompt may include text entered by a user that describes the desired task to be performed by the LLM engine 108. The LLM assistant server 118 may provide template prompts to the LLM assistant client 114. In an example, the LLM assistant server 118 may receive text input by a user into the LLM assist client 114, determine one or more suggested template prompts based on the text, and transmit the one or more suggested prompt templates to the LLM assistant client 114.

The LLM assistant server 118 receives the prompt from the LLM assistant client 114 of the client device together with one or more input documents. As described previously, the LLM assistant server 118 may receive copies of the one or more input documents together with the prompt. Alternatively, or additionally, the LLM assistant server 118 may receive indications of the one or more input documents, such as, for example, references or pointers to the one or more input documents stored in the memory 116 or the database 104, in which case the LLM assistant server 118 may retrieve copies of the one or more input documents utilizing the references or pointers.

In other embodiments, a user may provide the prompt directly to the LLM assistant device 106 utilizing a user input device (not shown) of the LLM assistant device. For example, a display (not shown) of the LLM assistant device may display a graphical user interface that the user may interact with, via a user input device, to input a prompt and select one or more input document associated with the prompt.

The LLM assistant server 118 provides the received prompt and one or more input documents to a fine-tuned language model engine 120 included at the LLM assistant device 106. The fine-tuned language model 120 generate structured data associated with at least one of the one or more input documents. As described in more detail below, the fine-tuned language model engine 120 may generate the structured data by linking spans of text found in the input documents to context-specific concepts. In particular, spans to text may be disambiguated to specific concepts related to the context such as, for medical contexts, specific medical concepts.

The fine-tuned language model engine 120 may be include one or more language models that are customized specific to a particular context that is associated with the one or more input documents. For example, the fine-tuned language model engine 120 may include a pre-trained language model that is fine-tuned to perform context-specific language processing tasks such as, for example, entity linking to context-specific ontologies and relation finding for various context-specific relation finding tasks. This fine-tuning may include, for example, further training the language mode using expert human feedback such as, for example, human labelled data, and information from context-specific ontologies. For example, in a medical context, the fine-tuned language model engine 120 may be trained using data annotated by medical experts and linking them to concepts from a medical ontology such as, for example, SNOMED-CT.

In an example, the LLM assistant device 106 may include multiple fine-tuned language model engines 120. For example, two or more of the fine-tuned language model engines 120 may be specific to different contexts such that one particular fine-tuned language model engine 120 may be utilized to generate structured data in one context, and another fine-tuned language model engine 120 may be utilized to generate structured data in another context. Alternatively, or additionally, two or more of the fine-tuned language model engines 120 may each include different language models that are directed to the same context.

The LLM assistant server 118 may then transmit the prompt, the one or more input documents, and the structured data generated by the fine-tuned language model engine 120 to the LLM engine 108, which performs a task associated with the prompt utilizing the one or more input documents and the structured data. The LLM assistant server 118 may also transmit instructions for the LLM engine 108 that instruct to use the structured data when performing the task.

The LLM engine 108 may be configured specific to the context. For example, in a medical context, the LLM engine 108 may be specifically trained utilizing medical documents or utilizing medical question-answer sets or other tasks to configure the LLM engine to specifically answer medical questions and/or perform tasks specific to the medical context, as described previously.

LLM engines, such as LLM engine 108, are based on next-token prediction and, while they might have “knowledge” that certain concepts exist within the context, they do not disambiguate which concepts exist in a document until the LLM engine has to predict a token in the output. The structured data in the present disclosure provides metadata, in addition to the one or more input documents, that augments the prompt with context-specific ontology-based disambiguation concepts from all of the input documents. The structured data may be utilized by the LLM engine as a reference, similar to, for example, a key or legend, when performing the task based on the one or more input document. Use of the structured data, in addition to the one or more input documents, may result in a reduction in the number of hallucinations that are generated in the output of the LLM engine 108 by reducing the instances in which the LLM engine 108 is forced to attempt to disambiguate concepts related to the text of the input documents.

Embodiments of the present disclosure align the output of the LLM engine to the concepts from context-specific ontology, such as for example SNOMED-CT in a medical context, to reduce hallucination instances.

Although the concepts included in the structured data may be based on context-specific ontology, which ontology may be similar to a knowledge base that is used in a RAG approach, structured data generated by the custom fine-tuned language models is used to augment the input documents with the relevant context-specific concepts necessary for the prompt instructions to be accurately followed by the LLM engine. This is in contrast to RAG approaches that merely provide portions retrieved from the source documents. The result of the present disclosure does not rely on retrieval of source documents, but rather enables the LLM engine to perform the task based on the entirety of the input documents, but with such task performance informed by the structured data.

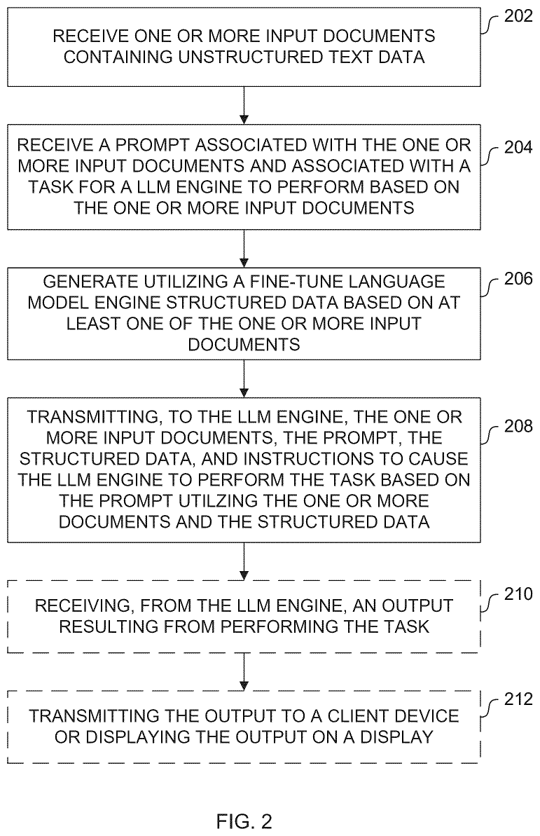

Referring now to FIG. 2, a flow chart showing an example method or process for providing a prompt input to an LLM engine is shown. The example method or process may be performed by a LLM assistant device such as, for example, the LLM assistant device 106 described previously with reference to FIG. 1. The method or process may be performed by one or more processors of the LLM assist device that execute computer-readable code stored in a non-transitory memory of the LLM assist device, the computer-readable code providing instructions to the one or more processor for performing the method or process.

At 202, one or more input documents that contain unstructured text data are received. The one or more input documents may be associated with a particular context. In an example, the one or more documents may be medical document such as, for example, patient medical records, that include unstructured data in the form of free-text notes. In other examples, the documents may be related to other contexts such as, for example, legal contexts, accounting contexts, financial contexts, business contexts, and the like.

At 204, a prompt associated with the one or more documents received at 202 is received. The prompt is associated with a task to be performed by an LLM engine based on the one or more input documents. The prompt may include text from a user that describes the task to be performed. For example, in a medical context, the text may include “summarize the patient's medical history based on the attached documents”, which is associated with the task of having the LLM engine analyze the documents and generate utilizing the documents a summary of the patient's medical history based on the contents of the documents. Alternatively, or additionally, the prompt may be a template prompt such as, for example, one of a plurality of template prompts that has been selected by a user, where each of the plurality of prompts is associated with a pre-defined task. In another example, receiving the prompt at 204 may include receiving the text from a user, then determining a prompt, such as template prompt, that best matches the received text.

In an example of a medical context, tasks that may be performed by an LLM engine in response to a prompt and based on the one or more input documents may include, for example, reading a list of insurance approval criteria for a drug or procedure and determining, based on the patient's medical document(s), if the patient meets the criteria to receive the drug or have the procedure performed. Other use cases may include preparing letters and patient summaries, and identifying patients for clinical trials by assessing if they meet inclusion/exclusion criteria for the trial.

Although the example method or procedure shown in FIG. 2 shows the one or more input documents being received at 202 and then the prompt being received at 204, in practice the one or more input documents may be received together with the prompt in, for example, a single communication event, or the prompt may be received prior to receiving the one or more input documents. In one example, the prompt and the one or more input documents may be received at the same time from a client device, such as for example, the client device 102 described previously with reference to FIG. 1. In this case, the client device may send copies of the one or more input documents, either from a local store or from a remote database, such as the example database 104 described previously with reference to FIG. 1.

In an example, the one or more documents and the prompt that are received at 202 and 204 are received at an LLM assistant server, such as the example LLM assistant server 118 described previously with reference to FIG. 1, that communicates with an LLM assistant client at a client device, such as the example LLM assistant client 114 at the example client device 102 described previously with reference to FIG. 1.

Alternatively, the prompt may be received directly from a user utilizing, for example, a user input device of the LLM assistant device. The prompt here may include one or more documents that are stored locally at the LLM assistant device, and/or the prompt may include indications of one or more input documents that are stored remote to the LLM assistant device.

In another example, the prompt and the one or more input documents may be received separately. For example, the prompt may be received with indications of the one or more input documents that are associated with the prompt such as, for example, references or pointers to locations in storage devices in which the one or more input documents are stored. The one or more input documents may be obtained based on the indications. For example, copies of the one or more documents may be obtained from a local memory at the LLM assist device, or a local memory of a client device, such as the client device that the prompt was received from or any other client device, or from a remote database, such as the database 104 described previously.

At 206, structured data based on the at least one of the one or more input documents is generated. The structured data may be generated at 206 utilizing a fine-tuned language model engine such as, for example, the fine-tuned language model engine 120 described previously with reference to FIG. 1.

In an example, the fine-tuned language model engine may be specific to a context that is associated with the one or more input documents. The fine-tuned language model may be trained using, for example, ontologies related to the context and/or other data that specific to the context. For example, the fine-tuned language model may be a pre-trained language model that is fine-tuned to perform context-specific language processing tasks such as, for example, entity linking to context-specific ontologies and relation finding for various context-specific relation finding tasks. This fine-tuning may include, for example, further training the language mode using expert human feedback such as, for example, human labelled data, and information from context-specific ontologies.

For example, in a medical context, the fine-tuned language model 120 may be trained using data annotated by medical experts and linking them to concepts from a medical ontology such as, for example, SNOMED-CT.

The structured data may identify concepts that are associated with spans of text that are present in the one or more input documents, may disambiguate ambiguous terms in the one or more input documents, may identify multiple concepts that are included in the one or more input documents and identify a relationship between the concepts.

Generating the structured data at 206 may include identifying spans of text in the one or more input documents and linking the identified spans of text to one or more context-specific concepts.

In an example, spans of text that include ambiguous terms may be identified, and the ambiguous terms may be disambiguated to specific concepts related to the context such as, for example, specific medical concepts in a medical context. In some examples, two or more concepts may be associated with an identified span of text, or spans of texts, and the structured data may include, in addition to the two more concepts associated with the span of text, a relationship among the two or more concepts.

Generating structured data may include identifying the text spans related to a concept in the one or more input documents, performing disambiguation for ambiguous strings in the text span, and including the structured data information linking ambiguous strings to the correct concept in the ontology. The generated structured data may also include medical entities for open-ended information like polarity (negation), measurements, temporality, qualifiers and identifying the person/people who experiences the medical entity so that, for example, family history is not conflated by the LLM engine with patient history.

The structured data may also identify codes from the context-specific ontologies and assign these codes in a verifiable way to the documents such as, for example, medical codes from medical ontologies. These codes are numeric, however they are utilized like as atomic strings, rather than numbers such that addition or multiplication of these numeric codes are meaningless. Such numeric codes may be a challenge for an LLM engine, which may not be able to identify what these context-specific codes mean, and often are not distinguished by a LLM engine from other numeric data included in the input documents. By identifying these context-specific codes in the structured data, the concepts associated with these codes are provided to the LLM engine as input which enables the natural in-context learning capabilities of the LLM engine.

In an example, the structured data may be formatted as an array or a table in which each row may include the following: (1) a span of text from the one or more input documents, (2) a concept identifier from a context-specific ontology that relates to the span of text, and 3. the fully specified name and/or a short unambiguous description of the concept. In this way, the structured data disambiguates the spans of text in the input documents with the appropriate concept based on the contextual information in the input document. In some examples, the structured data may include an additional array or table that that associates two or more concepts in a relationship.

In an example, “pt” may be a term included in the text in the one or more input documents to refer to “patient” or to “physiotherapy” or to a physical therapy service. In this example, the structured data generated at 206 may include, for example, a reference to the particular span of text in the input document and the concept that “pt” refers to, i.e., patient, or physiotherapy, or a physical therapy service, for disambiguation purposes, which the LLM engine 108 may utilize when performing the task. In this way, the ambiguous term “pt” in one or more of the input documents may be disambiguated.

At 208, the one or more input documents, the prompt, the structured data, and instructions to cause the LLM engine to perform the task based on the one or more input documents and the structured data are transmitted to the LLM engine.

The matched ontology concepts included in the structured data generated at 206 adds additional structured information and additional instructions to the LLM engine beyond the information included in the one or more input documents. This structured information may be used by the LLM engine to copy verifiable information from useful text spans in the input documents, including for example, the ontology concept identifiers. This copying is a behaviour used by the LLM engine to satisfy the instructions provided in the prompt, and by causing the LLM engine to copy structured information that has been disambiguated may result in the output generated by the LLM engine being more resilient to hallucinations.

By causing the LLM engine to perform the task based on the one or more input documents utilizing the structured data, the LLM engine may utilize the structured data as a reference to, for example, disambiguate ambiguous terms found in the one or more documents. In this way, ambiguous terms and concepts found in the one or more input documents are disambiguated by a fine-tuned language model engine that is context-specific and trained to disambiguate concepts using context-specific ontologies, rather than the LLM engine being forced to perform a task that it is not specifically trained to perform, i.e., disambiguate ambiguous information, which may result in hallucinations by the LLM engine in an attempt to resolve the ambiguity.

By including structured data together with the one or more input documents, as described above, the LLM engine is able to correlate and match the instruction in the prompt to the information included in the input documents and the structured information in the structured data order to follow the instructions included in the prompt to perform the task by producing the desired output. The decision making in an LLM engine is a very complex process that may involve billions of parameters. The structured data that is provided to the LLM engine in accordance with embodiments of the present disclosure augment the input context of the LLM engine to better enable the next token prediction capabilities of a LLM engine to find the right solution in a vast solution space.

In some examples, generating the structured data at 206 may comprise determining a context associated with the one or more documents, then determining a fine-tuned language model engine that is specifically configured for that context from among a plurality of fined-tuned language model engines that are each specific to a context. In this case, multiple fine-tuned language model engines may be provided in, or in association with, an LLM assistant device that are specific to different context. Then depending on the particular context the received one or more input documents and received prompt, a particular one of the fine-tuned language model engines may be utilized to generate the structured data. In this way, a single LLM assist device may be utilized to receive prompt and input documents in different contexts, generate context-specific structured data, then transmit the prompt, input documents, context-specific structured data to an LLM engine. In some examples, the LLM engine that the prompt, input documents, and structured data is transmitted to may depend on the determined context such as, for example, an LLM engine that is trained to perform context-specific tasks. In other examples, the context-specific structured data generated by the fine-tuned language model engine specific to that context may enable the non-context-specific LLM engine to perform the task.

Optionally, at 210, output from the LLM engine that results from performing the task based on the one or more input documents is received. In an example, the output may be received from the LLM engine at, for example, the LLM assistant server, such as the LLM assistant server 118 described previously.

Optionally, at 212, when the output is received at 210, the output may be transmitted to a client device, or displayed on a display. For example, the output may be transmitted to the client device that the original prompt was received from at 204. The output may be transmitted by, for example, an LLM assistant server to an LLM assistant client at the client device. Alternatively, or additionally, the output may be displayed on a display. For example, if the prompt is received at 204 from, for example, from a user via a user interface at the LLM assistant device, then the output may be displayed to the user on a display. In other examples, the output of the LLM engine may optionally be transmitted to any other device including, for example, a database, such as database 104 described previously, for storage.

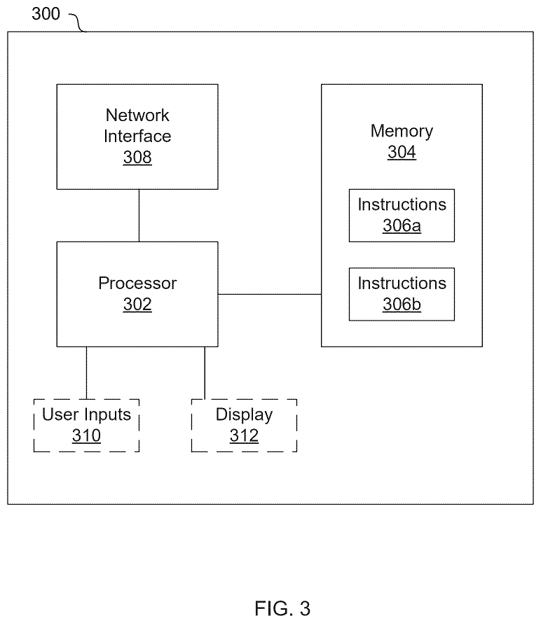

Referring to FIG. 3, a schematic diagram illustrating various physical and logical components of an exemplary apparatus 300 for a LLM assistant device in accordance with an embodiment is shown. Although an example embodiment of the apparatus 300 is shown and discussed below, other embodiments may be used to implement examples disclosed herein, which may include components different from those shown. Although FIG. 3 shows a single instance of each component of the apparatus 300, there may be multiple instances of each component shown.

The apparatus 300 includes one or more processors 302, such as a central processing unit (CPU), a microprocessor, an application-specific integrated circuit (ASIC), a field-programmable gate array (FPGA), a dedicated logic circuitry, a graphics processing unit (GPU), a tensor processing unit, a neural processing unit, a dedicated artificial intelligence processing unit, a hardware accelerator, or any other suitable hardware processing circuitry, or combinations thereof. The one or more processors 302 may collectively be referred to as a processor 302.

The apparatus 300 also includes one or more memories 304 (collectively referred to as “memory 304”), which may include a volatile or non-volatile memory (e.g., a flash memory, a random-access memory (RAM), and/or a read-only memory (ROM)). The non-transitory memory 304 may store instructions for execution by the processor 302. In some embodiments, instructions 306 of a LLM assistant device, a LLM assistant server, or a fine-tuned language model engine, as described herein, such as the LLM assistant device 106, the LLM assistant server 118, and the fine-tuned language model engine 120, of the example system 100, may be stored in the memory 304, and the instructions 306 may be executed by the processor 302 to perform the actions or operations of the methods or processes described herein.

The apparatus 300 may also include one or more network interfaces 308 for connecting to a network, such as the network 110, for communication with, for example, a client device, such as client device 102 of the example system 100, a database, such as the database 104 of the example system 100, and a LLM engine, such as the LLM engine 108 of the example system 100.

The apparatus may optionally include a user input 310 for receiving input from a user of the apparatus 100 and a display 312. The user input 310 may be utilized, for example, for a user to interact with a graphical user interface displayed on the display 312 in order to input a prompt and/or select input documents for a task to be performed by an LLM engine. In this case, the prompt may be received directly from the user, via the user input 310, rather than from a client device.

In some examples, the apparatus 300 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the computing system 300) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 604 to implement data storage, retrieval, and caching functions of the apparatus 300.

The components of the apparatus 300 may communicate with each other via a bus. In some embodiments, the apparatus 300 may be a processing system implementing functionality of the LLM assistant device described herein, such as the LLM assistant device 106 of the example system 100 previously described with reference to FIG. 1. In some embodiments, the apparatus 300 may be distributed computing system and may include multiple computing devices in communication with each other over a network, as well as optionally one or more additional components. The various operations described herein may be performed by different computing devices of a distributed computing system in some embodiments. In some embodiments, the apparatus 300 may be a cloud computing system or may be a virtual machine provided by a cloud computing system.

Embodiments of the present disclosure enable the generation of structured data by a fine-tuned language model based on one or more input documents that are associated with a prompt for a LLM engine. The structured data may identify concepts that are associated with spans of text that are present in the one or more input documents, may disambiguate ambiguous terms in the one or more input documents, may identify multiple concepts that are included in the one or more input documents and identify a relationship between the concepts. The structured data is then provided to the LLM engine with the prompt and the one or more input documents with instructions to cause the LLM engine to utilizing the structured data when performing a task associated with the prompt based on the one or more input documents. Utilizing the structured data, generated by a fine-tuned language model, by the LLM engine while performing the task based on the one or more input documents may result in fewer hallucinations being present in the output of the LLM engine.

Embodiments of the present disclosure provide a technical solution to the technical problem of reducing hallucinations generated by LLM engines. Generating structured data by a fine-tuned, context-specific, language model engine may reduce the hallucinations generated by the LLM engine that performs the task based on one or more input documents, resulting in an improvement in the functioning of the computer system. Further, having a fine-tuned, context-specific, language model engine that generates structured data utilizing the one or more input documents enables a task to be performed on the one or more input documents by a generalized LLM engine, i.e., not fine-tuned.

Embodiments of the present disclosure improvement in the functioning of a computer system that includes a LLM engine by enabling the LLM engine to more accurately predict the next token in a sequence of text that provides the solution to a task that is associated with an input text prompt in order to perform a specific task. Embodiments of the present disclosure work in concert with a LLM engine to enable the LLM engine to more accurately predict each next token when performing a task, thus improving the function of the overall computer system.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

As used in the present disclosure, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (iii) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in the present disclosure, the term circuitry also covers an implementation of merely a hardware circuit or processor (or multiple processors) or portion of a hardware circuit or processor and its (or their) accompanying software and/or firmware.

The functions, processes, and operations described herein may be performed in a different order, or may be performed concurrently with each other, or a combination thereof. Furthermore, one or more of the functions, processes, and operations may be optional or may be combined. It will be appreciated that the flow diagram shown in FIG. 2 and the various embodiments described with reference to FIG. 2, are examples only. Various operations and processes depicted therein may be omitted, may be reordered, may be combined, or a combination of reordered and combined.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A method for providing prompt input to a large language model (LLM) engine, the method comprising:
receiving one or more input documents containing unstructured text data;
receiving a prompt that references the one or more input documents and is associated with a task for the LLM engine to perform utilizing the one or more input documents;
generating, utilizing a fine-tuned language model engine, structured data based on at least one of the one or more input documents; and
transmitting, to the LLM engine, the one or more input documents, the prompt, and the structured data together with instructions to cause the LLM engine to perform the task based on the one or more input documents and the structured data.

2. The method according to claim 1, wherein generating the structured data comprises:
identifying, in the one or more input documents, a span of text; and
identifying a concept that is associated with text included in the identified span of text;
wherein the structured data includes the identified concept and an identification of the identified span of text associated with the identified concept.

3. The method of claim 2, wherein identifying a concept associated with the text in the identified span of text comprises performing disambiguation of an ambiguous term included in the span of text.

4. The method of claim 1, wherein identifying the concept that is associated with text included in the identified span of text comprises identifying two or more concepts associated with the text included in the span of text and a relationship between the two or more concepts.

5. The method of claim 1, wherein the one or more input documents are associated with a context, and the fine-tuned language model engine is specific to the context.

6. The method of claim 5, wherein the context is medicine, and the one or more input documents are patient medical documents.

7. The method of claim 6, wherein the fine-tuned language model engine specific to the context is trained using medical ontologies and human labelled medical data.

8. The method of claim 7, wherein the medical ontologies include SNOMED-CT.

9. The method of claim 1, further comprising receiving from the LLM engine an output resulting from performing the task based on the one or more input documents and the structured data.

10. The method of claim 9, further comprising transmitting the output to a remote device, or displaying the output on a display.

11. An apparatus for providing prompt input to a large language model (LLM) engine, the apparatus comprising:
at least one processor;
at least one memory stored instructions wherein the instructions, when executed by the at least one processor, cause the processor to:
receive one or more input documents containing unstructured text data;
receive a prompt that references the one or more input documents and is associated with a task for the LLM engine to perform utilizing the one or more input documents;
generate structured data based on at least one of the one or more input documents; and
transmit, to the LLM engine, the one or more input documents, the prompt, and the structured data together with instructions to cause the LLM engine to perform the task based on the one or more input documents and the structured data.

12. The apparatus according to claim 11, wherein the instructions, when executed by the at least one processor, cause the processor to generate the structured data comprises instructions that, when executed by the at least one processor, cause the processor to:
identify, in the one or more input documents, a span of text;
identify a concept that is associated with text included in the identified span of text;
wherein the structured data includes the identified concept and an identification of the identified span of text associated with the identified concept.

13. The apparatus of claim 12, wherein the instructions, when executed by the at least one processor, cause the processor to identify a concept associated with the text in the identified span of text comprises instructions that, when executed by the at least one processor, cause the processor to perform disambiguation of an ambiguous term included in the span of text.

14. The apparatus of claim 11, wherein the instructions, when executed by the at least one processor, cause the processor to identify the concept that is associated with text included in the identified span of text comprises instructions that, when executed by the at least one processor, cause the processor to identify two or more concepts associated with the text included in the span of text and a relationship between the two or more concepts.

15. The apparatus of claim 11, wherein the one or more input documents are associated with a context, and the structured data is generated by a fine-tuned language model engine that is specific to the context.

16. The apparatus of claim 15, wherein the context is medicine, and the one or more input documents are patient medical documents.

17. The apparatus of claim 16, wherein the fine-tuned language model engine specific to the context is trained using medical ontologies and human labelled medical data.

18. The apparatus of claim 17, wherein the medical ontologies include SNOMED-CT.

19. The apparatus of claim 11, wherein the instructions, when executed by the at least one processor, further cause the processor to receive from the LLM engine an output resulting from performing the task based on the one or more input documents and the structured data.

20. A computer readable medium having stored thereon computer-readable instructions that, when executed by at least one processor, cause the processor to:
receive one or more input documents containing unstructured text data;
receive a prompt that references the one or more input documents and is associated with a task for the LLM engine to perform utilizing the one or more input documents;
generate structured data based on at least one of the one or more input documents; and
transmit, to the LLM engine, the one or more input documents, the prompt, and the structured data together with instructions to cause the LLM engine to perform the task based on the one or more input documents and the structured data.
